(19) United States
(12) Patent Application Publication
(10) Pub. No.: US 2004/0125127 A1
(43) Pub. Date: Jul. 1, 2004

(54) System and method for video-based online interview training

(76) Inventor: Beizhan Liu, Toronto (CA)

Correspondence Address: Beizhan Liu, 204-530 Kingston Road, Toronto, ON, M4L 1V4, CA

(21) Appl. No.: 10/662,466

(22) Filed: Sep. 16, 2003

Related U.S. Application Data
(60) Provisional application No. 60/411,711, filed on Sep. 19, 2002.

(51) Int. Cl. G09G 5/00

(52) U.S. Cl. 345/716

(57) ABSTRACT

A system and method that provide video-based online interview training are disclosed. An architecture defining an integrated environment for job seekers to practice interview is described. With this system, the owner can manage the video questionnaire database. Users can book an interview, select the specific video questionnaire list and practice their interview. Users can record their interview results to the database. They can choose to get their interview results be reviewed by professional interview experts. The system administrator/owner can define the price policy and receive payment on the pay per-use basis. The system administrator/owner can also manage the user's account which includes log in history, payment, pre-recorded video database, recorded response video database, The system can also have the function to link with the affiliates' web site and manage the commissions.

### CROSS REFERENCE TO RELATED APPLICATION

This application claims the priority benefit from U.S. Provisional Patent Application No. 60/411,711, filed on Sep. 19, 2002.

This application is also related to my previously filed U.S. patent application Ser. No. 10/314,625 filed on Dec. 10, 2002 and international application with No. PCT/IB02/05045 filed on 2 Dec. 2002.

### FIELD OF THE INVENTION

The presented invention are combination of realities that using the VRP technology described in my U.S. patent application with a Ser. No. 10/314,625 filed on Dec. 10, 2002 and international application with No. PCT/IB02/05045 filed on 2 Dec. 2002. It relates to the video-based online interview training. Specially this invention is related to a system and method for the user to take an instant training, book a training, take an interview, record the interview results and ask for specific service from the experts. The system can let the owner to manage the user's account, the pre-recorded video (question video) database, the practice results reviewing and advising, the affiliates and commissions.

### BACKGROUND OF THE INVENTION

In modern society, interview is a very common social activity and is more and more important for us to prepare. However, there are not much tools or equipment for us to use. Normally we watch other people's interview in videotapes. We record our own answers with video recorder and then replay them. Sometime we ask our friends to watch and provide advices. All such methods are not convenient, not professional and not profitable. I experience such things during my interview preparation. The more practice for the interview, the more confidence to win the interview. There are a lot people need to practice their interview, such as the new graduates from schools or universities, the jobseekers, the immigrants, the immigration applicants, etc.

So with such real problems and real user groups, it is needed to have an integrated and convenient interview-training tool. This invention has met the requirements. It is an online, convenient and profitable integrated environment with professional service.

With this invention, the user can just log in the system through the internet, establish and open an account, book the time for the practicing and then he can practice the interview, he can record the interview results in the database, he can also request advices for his training from experts, he can also take interview as booked through employers.

With this invention, the system owner can manage the pre-recorded video (question video) database, user account, practicing results and advising, the affiliates and commissions.

### SUMMARY OF THE INVENTION

So it is therefore an object of the present invention to provide a video-based interview training tool for the job seeker and a profitable tool for the human capital industry. This tool can also be used in other business applications as I mentioned in my related patent application;

It is a further object of the invention to provide a method to manage the users and their using history of the system. It also provides us a method for the administrator to manage the system;

It is an additional object of the invention to provide a new business method, which the business owner can collect money from customers for the service based on time. This method can be applied to any kind web sites or web services;

The presented invention also provides a method to let other web sites to have a link with this system. The owner or administrator of the system can manage the affiliates and their commissions;

The presented invention provides a method to let the user to register with the system. The user can select the using type of the system, such as taking an instant training, booking a training, taking a booked training, taking an interview for a specified employer and job position and view his using history. After finishing the use of the system, he can log out from the system;

When doing an interview training, the user can select the training video from the pre-recorded video database with industry and job title. He also can specify the training purpose and the payment method;

When booking an interview training, the user can choose the start time (day, hour, minute) and finish time (day, hour, minute), the industry title, job title, the purpose of the training and the payment method;

A further aspect of the invention is that this system comprising a pre-recorded video database of different question video clips. Such video clips are related with the industry title and job title;

This invention also comprising a response video database for storing the recorded answer video;

### SPECIFICATIONS OF THE INVENTION

A system and method comprising: audio and video capture device on the client side, the web server, the video reality processing GUI, the pre-recorded video (questionnaire) database and recorded response video database, the user's account, login and booking system, the system management facility.

The system owner can create and manage the video questionnaire database. The system owner can manage the user's account. The owner can manage the commissions for the affiliates.

The user can create an account and log in the system. The user can book the time for the interview practice. The user can record the interview result to the response video database. The user can choose to have their answer be reviewed by human resource experts.

The user can take interview as booked through employer. The system can be affiliated with other website pages.

FIG. 2 shows the brief architecture of the online interview training system.

FIG. 1 shows the detail functions of the system. The first step is that the user (from the owner's homepage or from the affiliate's web page) to sign on and create his/her own account or login the system if he/she already has an account. Then he/she can choose the different functions for using the system, such as taking an instant training, taking a booked training, booking a training, taking an interview, viewing his using history. After that, he/she can log out from the system.

FIG. 3 shows the architecture of the VRP (Interviewer/Interview Trainer). VRP means Video Reality Producer which I already included in my related patent applications. FIG. 4 shows the simplified diagram of the system and process of VRP (Interviewer/Interview Trainer). The realities produced here in this invention are interviewer and interview trainer.

FIG. 5 shows the functional model for the system administration. The first step is that the administrator logs in the management system. Then he/she can manage the system through different queries, such as user, system usage, interview & interview training results processing, login history, video database, employer, and affiliates. Then he/she can log out from the system.

FIG. 6. shows the simplified diagram of VRP(Interviewer/Interview Trainer) Presentation Interface.

The system owner can add the sample answer database and the review & advice facility as optional functions as I mentioned in the provisional patent application upon requirements.

The system owner can also add real-time interview as optional function if he/she wanted.

### BRIEF DESCRIPTION OF THE DRAWINGS

FIG. 1. Functional Model for Online Interview Training;

FIG. 2. Online Interview Training System Architecture;

FIG. 3. VRP (Interviewer/Interview Trainer) Architecture;

FIG. 4. The Simplified Block Diagram of the System and Process of VRP(Interviewer/Interview Trainer);

FIG. 5. Functional Model for System Administration;

FIG. 6. Simplified Diagram of the VRP (Interviewer/Interview Trainer) Presentation Interface;

FIG. 7. The Example Affiliate Page;

FIG. 8. The User Login Page;

FIG. 9. The Functional Control Interface;

FIG. 9.1 The Functional Control Interface for Instant Training;

FIG. 10. The Start Page of Instant Training;

FIG. 11. The In-Process Page of Instant Training;

FIG. 12. The Result Page of Completed Instant Training;

FIG. 13. The Request Page for Processing Instant Training Result;

FIG. 14. The Processing Result Page for The Instant Training Result;

FIG. 15. The Book Training Page;

FIG. 16. The Book Training Result Page;

FIG. 17. The Start/Login Page for Booked Training

FIG. 18. The In-Process Page for Booked Training;

FIG. 19. Take Interview Page Requested by a Specific Employer;

FIG. 20. The In-Process Page for Interview;

FIG. 21. The Administrator Log In Page;

FIG. 22. The Administrator Control Interface;

### DETAILED DESCRIPTION OF THE INVENTION

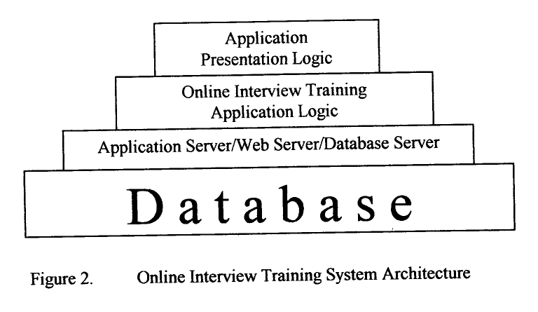

FIG. 2 presents the architecture of the online interview training system. The core interview training logic is integrated with the database and appropriate server. The application presentation logic is displayed on the client side with audio video capture devices. The database contains pre-recorded (question) video, recorded response video, user information, using history, affiliates and commissions and booking information, etc.

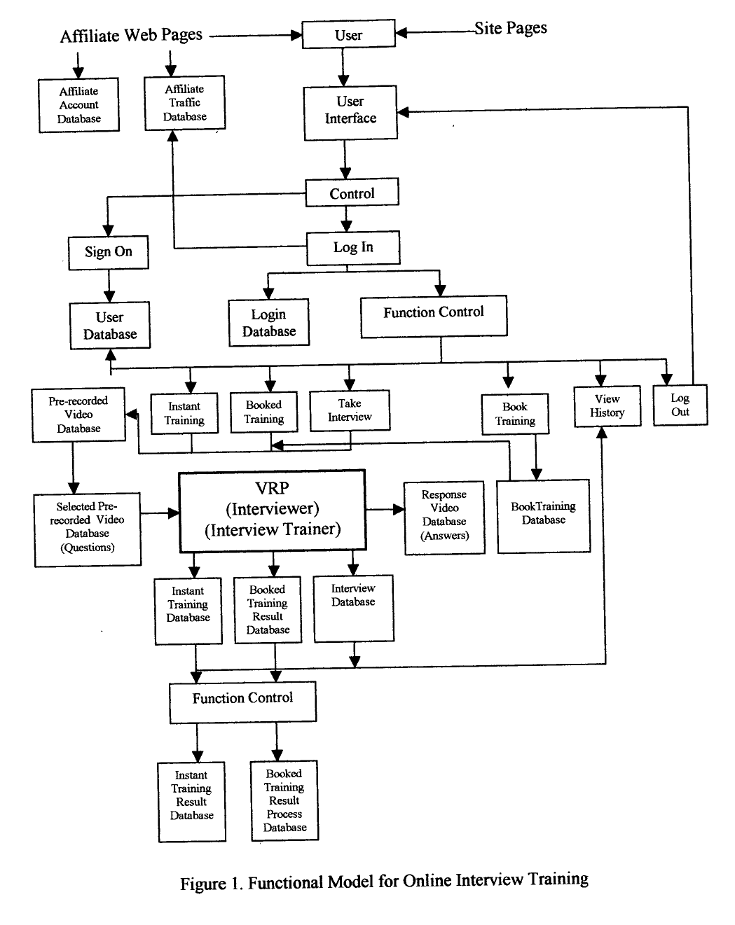

FIG. 1 presents the functional model for the online interview training. The customer or user can enter the system from the owner's site page or from the affiliate web page. If the user is from the affiliates' web page, the related affiliate information is recorded by the system. The affiliate account information is stored in a database separately. At the start point, the user can choose to login the system with his account name and password if he is already registered with the system. Otherwise, he can register with the signing on facility. When he signs on the system, he can specify his membership type, such as one month, two month, three month, half year, or one year. The basic user information is also recorded in the user database.

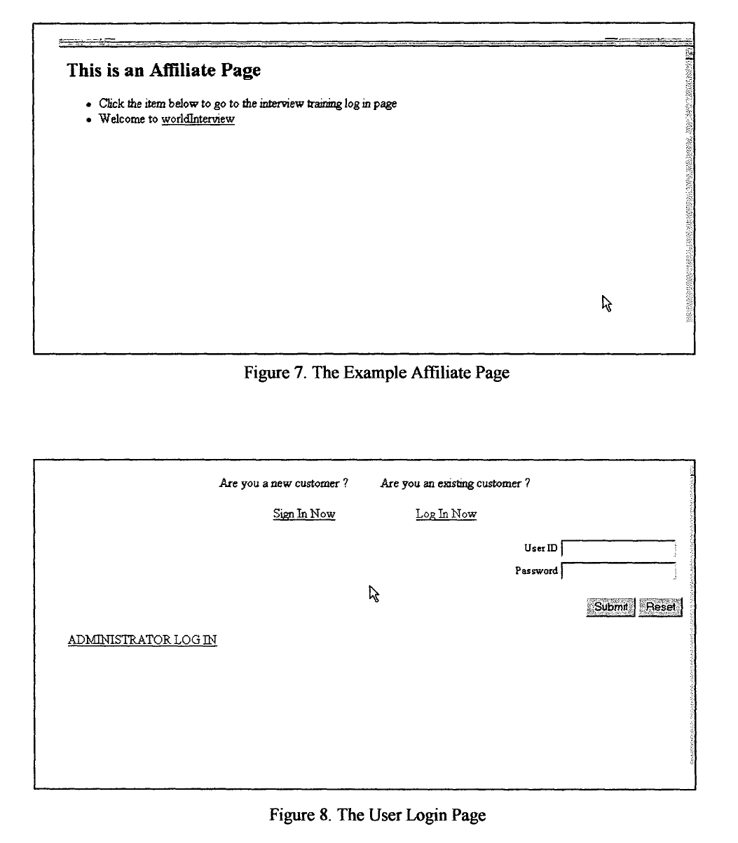

When the user login the system, the login time are recorded in the login database together with the user's information. Then the user can choose the using type with the function controls, such as taking instant training, taking booked training, taking interview, booking training, viewing using history and logging out. The selected using type, such as instant training, booked training and interview can be recorded in the login database. See FIGS. 7, 8, 9, 9.1.

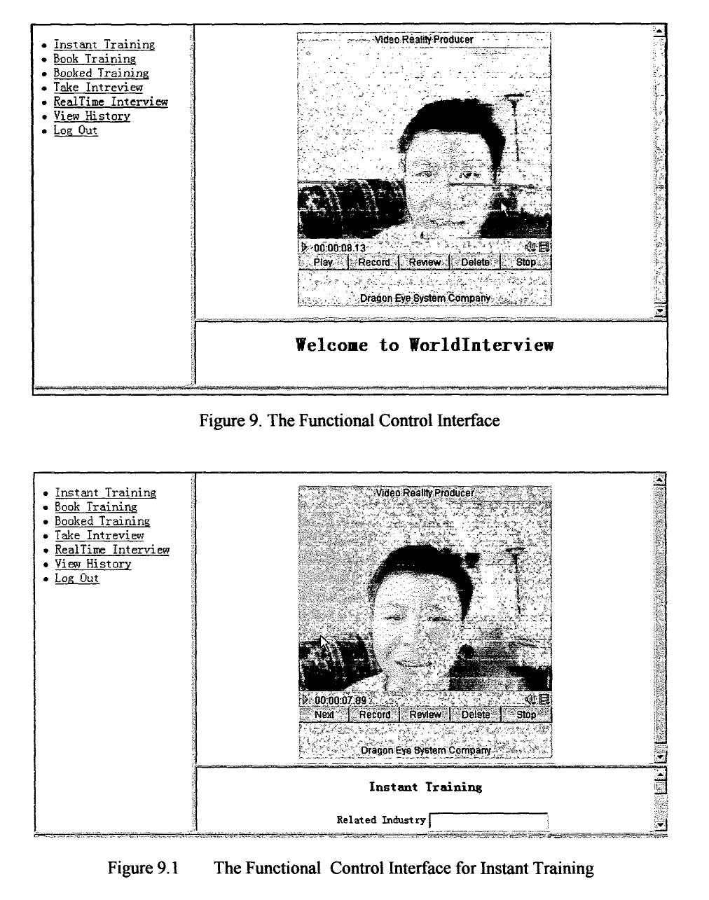

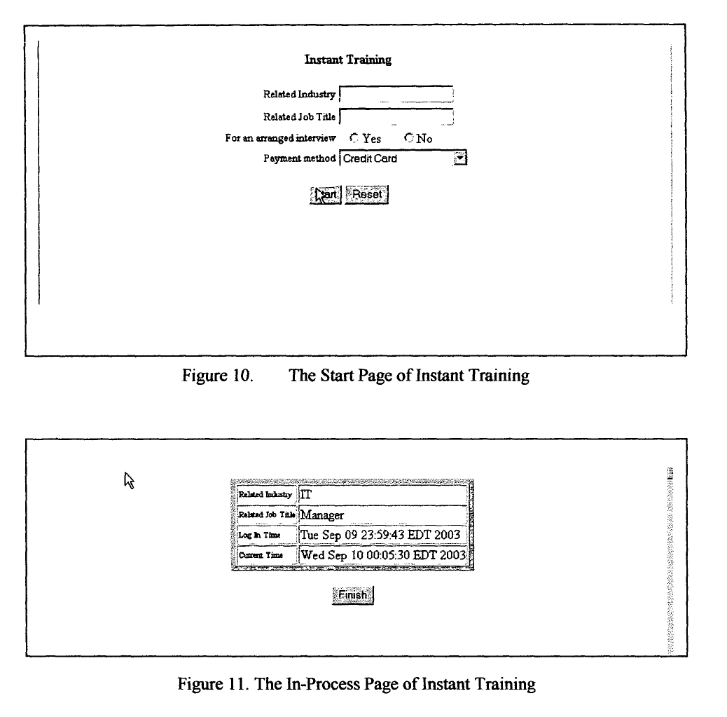

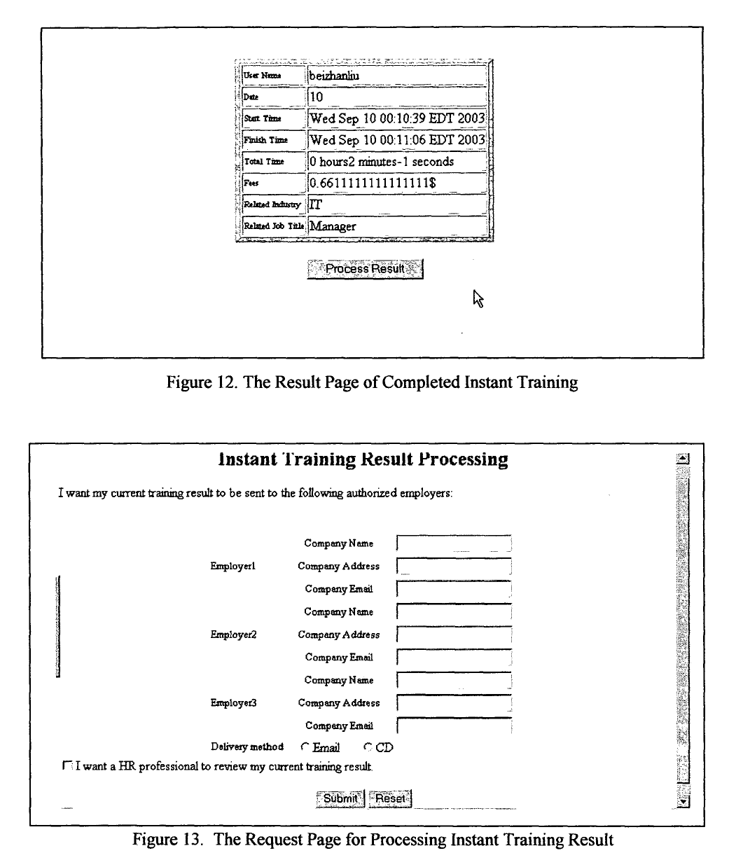

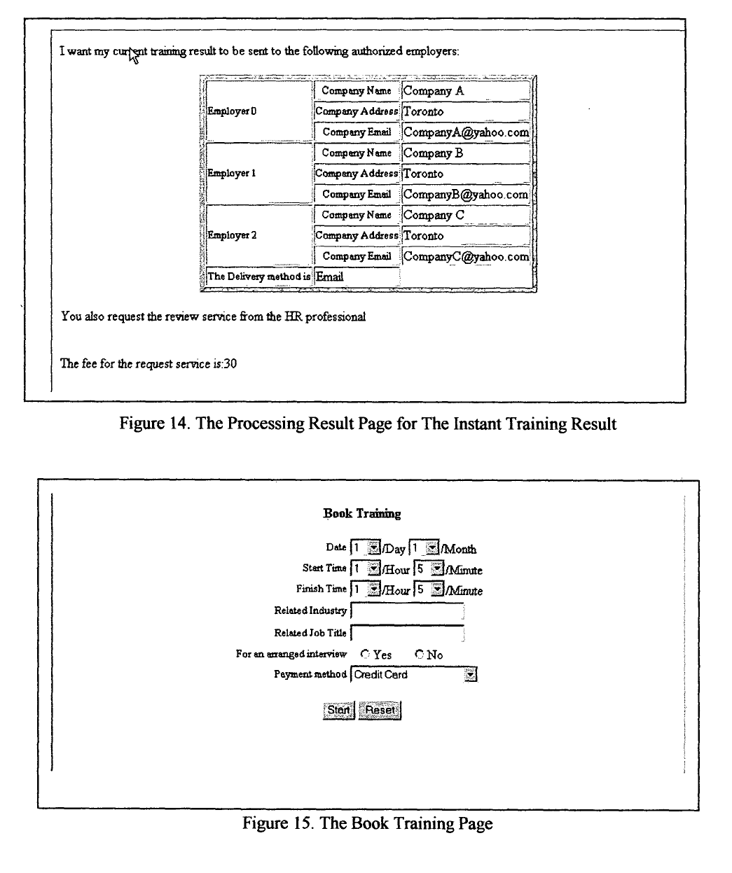

If the user chooses to do instant Training, the instant training page will appear. The user can fill in the related industry, related job title, the training aim and the payment method in the form and then start the required training. The payment method can be: by credit card, by check or by cash on site. Such information is recorded in the instant training database. When he finishes the required training, the finishing time and related fee are also recorded in the instant training database, The time based fee policy is managed by the system administrator. The result of the instant training are displayed. Then the user can request to process the training result. He can choose to have the training results to be sent to one, two or three companies. He can specify the delivery method. He can also ask Human Resource professional to review his training results. Finally he will get a confirmation page for his result process request. See FIGS. 9, 9.1, 10, 11, 12, 13, 14.

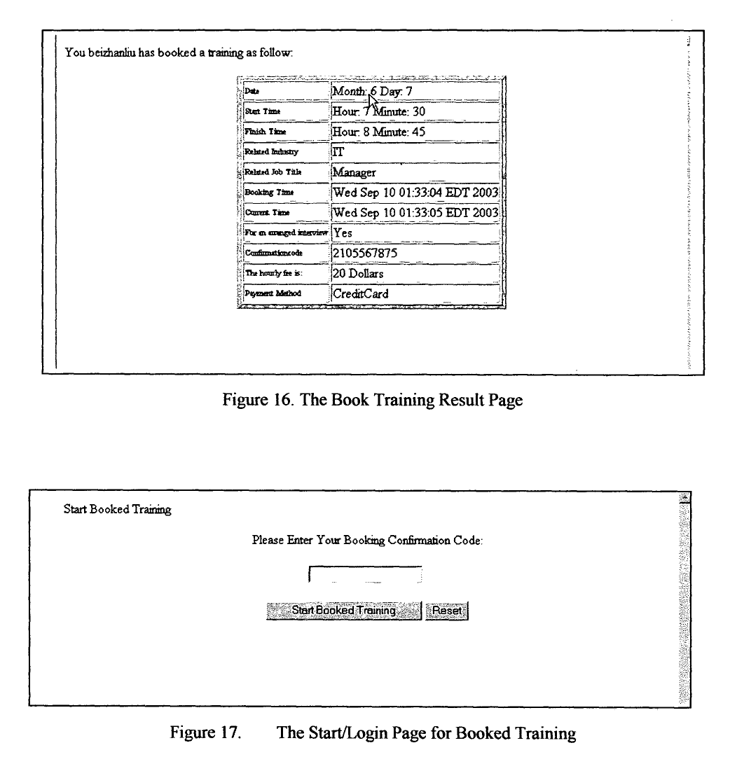

If the user chooses to book a training, the book training page will appear. The user can choose the date (day and month), start time (day, hour, minute) and finish time (day, hour, minute), the relate industry title, relate job title, the purpose of the training and the payment method. The booking result can be present to him when finished. He can also get a confirmation code for this booking. See FIGS. 15, 16.

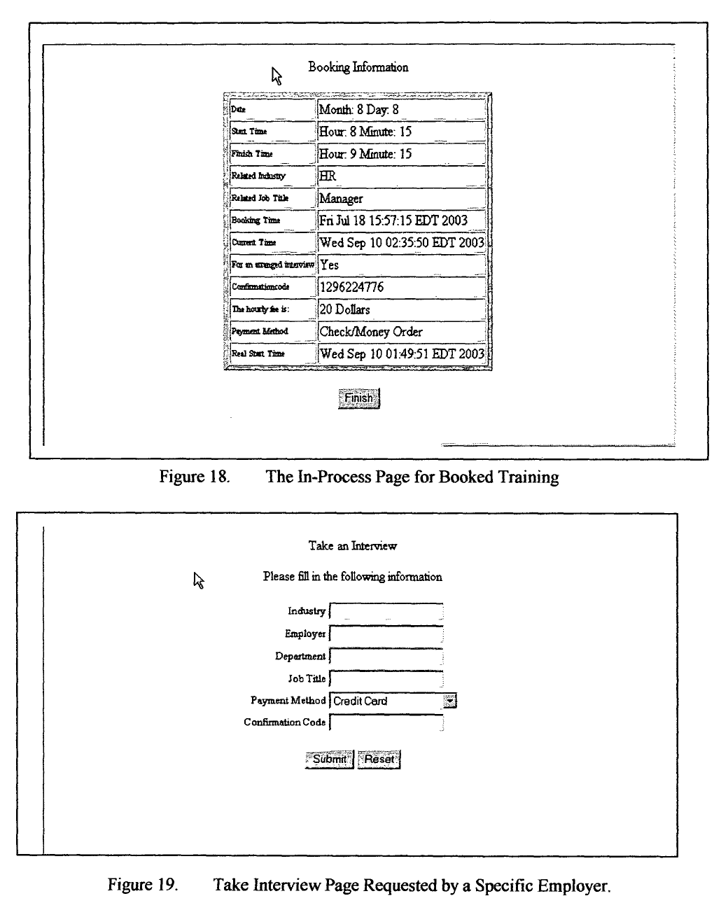

If the user chooses to start a booked training, he need to fill in the booking confirmation code in the booked training login page. Then he can start the booked training with the booked training interview questions which related with the industry and job title. The procedure for processing the training results are similar to the instant training. See FIGS. 17, 18.

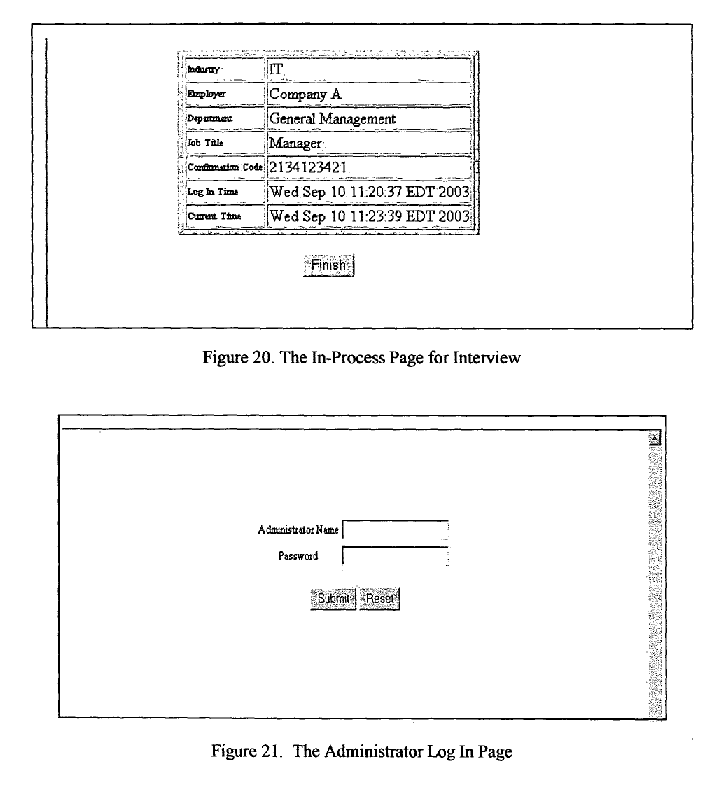

If the user chooses to take an interview, which is requested by a specific employer, he can fill in the requested information in the form in FIG. 19. Then he can get the interview questions and start his interview. See FIGS. 19, 20.

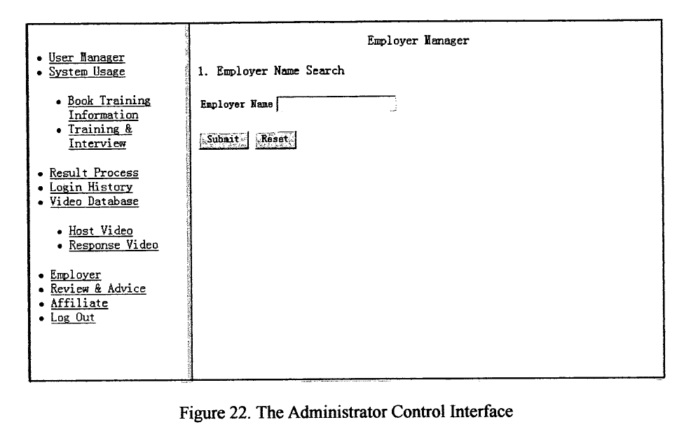

The administrator can login the system for administration. He can do user name query in different database for getting user information and user related system information. He can also build and edit the pre-recorded video (question video) database. He can also view the recorded response video. See FIGS. 21, 22.

FIGS. 9 and 9.1 are the basic functional control interface for the user to use the system. There are three frames. The left frame is control frame for displaying the function controls. The up-right frame is VRP frame for displaying the VRP(Interviewer/Interview Trainer). The lower-right frame is content frame for displaying the selected function form, such as Instant Training, Booked Training login, Take Interview, etc.

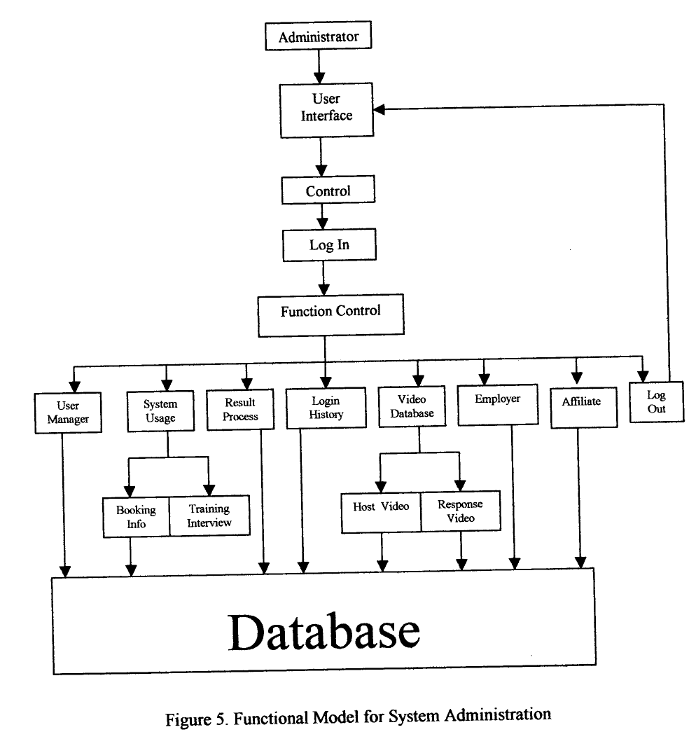

FIG. 5 shows the functional model for the system administration. FIG. 22 is the basic functional control interface for the administrator to administrate the system. There are two frames. The left frame is control frame for displaying the function controls. The right frame is content frame for displaying the selected function form, such as user manager, booking information, training and interview information, login history, prerecorded video, response video, employer, review & advice, affiliate and logout.

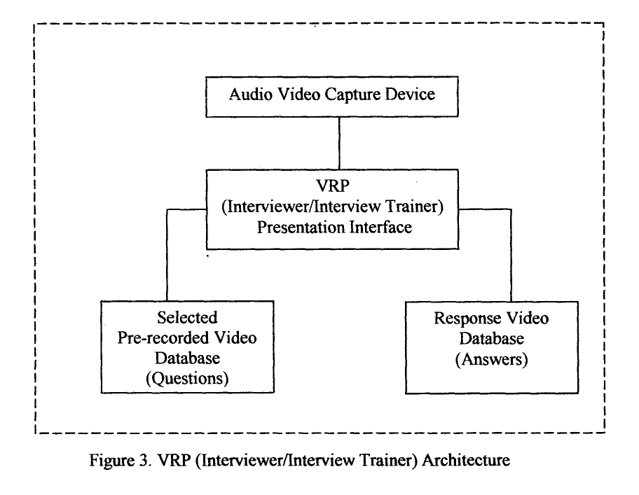

FIG. 3 shows the detail architecture of the invented VRP (interviewer/Interview Trainer). It includes audio/video capture devices, The VRP presentation interface, the pre-recorded video database and the response video database.

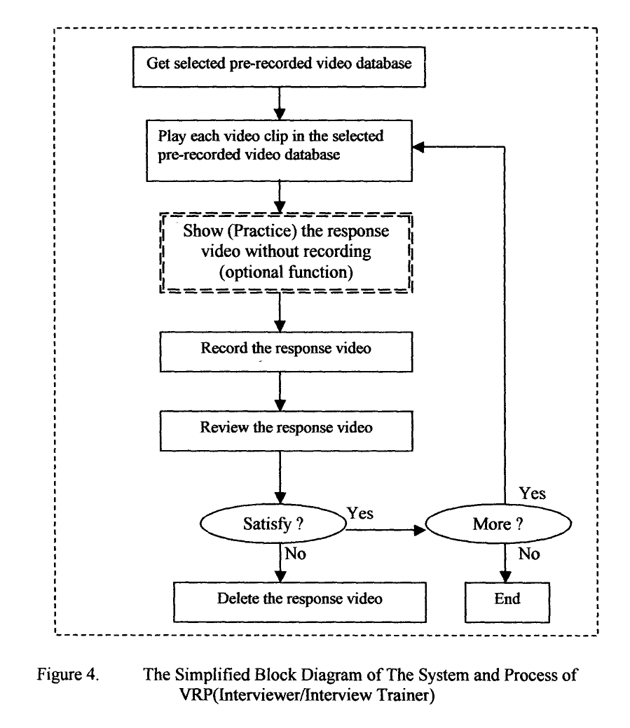

FIG. 4 shows the detail steps of the process of the VRP system (interviewer/interview trainer). During the instant training, booked training and interview, when the user start the system with the related job title and related industry, the specific selected pre-recorded video (here is question video) database will be built. Then the user start to play. After playing one of the video clips in the selected host video database. The user starts to response this video clip. There is an optional function that the user can first show his response without recording. That means he can have a practice first. Then he records a response video. He can review the recorded response video. If he satisfied, he start to play the next video clip in the question video set, otherwise he deletes the recorded response video and start to record a new response video. When he finishes the play of all the video clips in the selected pre-recorded video database, he gets a specific response video set in the database. That's his training or interview result.

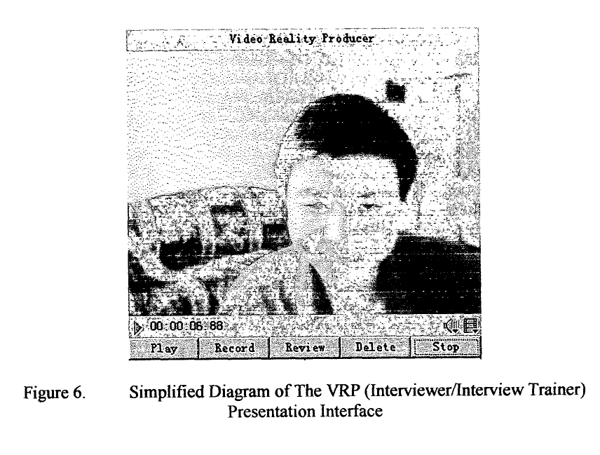

FIG. 6 shows the VRP (interviewer/interview Trainer) presentation interface and function control panel (including different command buttons, such as play, next, practice (optional), record, review, delete and stop).

I claim:

1). A system and method for video based online interview training comprising: audio and video capture device on the client side, the web server, the video reality processing GUI, the pre-recorded video (questionnaire video) database and recorded response video database, the user's account, login and booking system, the system management facility;

2). The said system in claim 1 includes a core VRP (video reality producer) process as below: The user(s) can play the video clips in the selected pre-recorded video database. When finishing the play of one video clip in the video set. The user starts to record his response video. And then he can play the next video clip in the selected pre-recorded video database. After that he starts to record the response video again. When playing all the video clips in the selected pre-recorded video database, he creates a response video database;

3). The said process in claim 2 further includes the following steps:
After the user(s) record a response video, he can review the response video;

4). The said process in claim 2 can further include: before the user(s) start to record the response video, he can show the response video or make a practice for the response without recording;

5). The said process in claim 2 further includes: after the user(s) review the response video, if he accepts it, he starts to play the next video clip in the selected pre-recorded video database. Otherwise, he deletes the recorded response video and restarts to record the response video again;

6). The said pre-recorded video in claim 1&2, as a kind of content, could be the audio clips and also could be any kind content data with any kind formats such as graphics, images, flashes, slides, text-documents, or mixed data. The content can be question video, training video, entertainment video, consulting related video, testing related video, journalist video, dating video, language video, security related video, etc. And the said system in claim 1 could have different name;

7). The said response video in claim 1&2, as a kind of content, could be the audio clips, could be the content data with any kind formats and also could be the processing results of the response video with some kind methods;

8). The said pre-recorded video and response video in claim 1&2 could be managed with any kind appropriate methods and stored with any kind storage means, such as one or more video lists, one or more video sets, one or more video database, and the said database in claim 1&2 could have one or more video clips;

9). The said process of claim 2 wherein the user is prompted via internet, intranet or any kind communication network;

10). The said process of claim 2 wherein the user is prompted via the use of a wireless device, a handheld device, a kiosk device, a control device or any kind standalone device;

11). The said web server in claim 1 could be the application server or database server or any other kind appropriate server;

12). The said system in claim 1 includes means for user to sign on and/or login and select the system functions as below: The user either from affiliate web pages or from the site pages first can sign on the system and create an account if he do not have an account. The user can choose the membership type for the system. If the user has an account with the system, he can login the system with his account name and password;

13). The said system in claim 1 also includes means for user to choose the following different functions of the system after he login the system: taking instant training, booking a training, taking a booked training, taking an interview, viewing his using history, and logout;

14). The said taking instant training in claim 13 includes the sub-steps of: collecting related industry, related job title, the aim of training and payment method information from the user; displaying the related industry, job title, login time and current time in the content frame; building a specific temporary question video set from the pre-recorded video database according to the related industry and job title; using the VRP to take the instant training; obtaining a recorded response video database for the user when finishing the instant training; displaying the instant training timing results in the VRP frame, such as user name, start time, finish time, total time, fees, related industry, and related job title;

15). The said booking a training in claim 13 includes the sub-steps of: collecting booking information from the user, such as start time (day, month, hour, minute), finish time (day, month, hour, minute), related industry, related job title, the training aim and payment method; displaying the booking information (including the booking confirmation code and fees) in the VRP frame;

16). The said taking a booked training in claim 13 includes the sub-steps of: logging in the booked training subsystem with booking confirmation code; displaying the booking information in the content frame; building a specific temporary question video database from the pre-recorded video database according to the related industry and job title; using VRP to take booked training; obtaining a recorded response video database for the user when finishing the booked training; displaying the booked training timing results in the VRP frame, such as user name, start time, finish time, total time, fees, related industry, and related job title;

17). The said taking an interview in claim 13 includes the sub-steps of: collecting interview information from the user, such as industry, employer, department, job title, payment method and confirmation code; displaying the interview information in the content frame; building a specific temporary question video database from the pre-recorded video database according to the industry and job title; using VRP to take the interview; obtaining a recorded response video database for the user when finishing the interview; displaying the interview timing results in the VRP frame, such as user name, start time, finish time, total time, fees, industry, job title, employer and department;

18). The said taking instant training, taking a booked training in claim 13, 14, 16 further includes sub-steps of displaying the training result processing request page in the VRP frame; collecting the employer information which the user want to send their training result, the delivery method and choice for requesting the professional HR review service; displaying the result processing page in the VRP frame which show the target employer's name, the delivery method, and the fee for the delivery service;

19). The said system in claim 1 includes means for the administrator to login the system with administrator name and password to perform administration task which includes: querying the system with user name for user information, system usage, result process, login history and response video; building (importing new video clips) and edit (deleting video clips) the pre-recorded video database; looking up the record response video of specific user; querying employer with employer name; querying affiliate with affiliate name; querying review & service with HR expert name;

20). A method for charging the service fee based on time for online application comprising: defining the hourly fee for the service; defining the start time for using the VRP in instant training, booked training and interview; recording the finish time when completing the use of the system, then calculating the final fee charged for the service;

21). The said service fee in claim 20 could also be charged according to the user's membership type, such as one month, two month, three month, half year, and one year membership which is specially associated with the said system in claim 1;

22). The said method in claim 20 could be applied in any kind online business application;

23). The real-time interview as an optional function could also be integrated with the system.
